(19) United States
(12) Patent Application Publication
(10) Pub. No.: US 2004/0255112 A1
(43) Pub. Date: Dec. 16, 2004

(54) Network device and system for authentication and method thereof

(75) Inventors: Cheol-won Choi, Seoul (KR); Kyoung-hoon Yi, Seoul (KR); Hyun-sik Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/817,945

(22) Filed: Apr. 6, 2004

(30) Foreign Application Priority Data
Apr. 16, 2003 (KR) 10-2003-0024170

(51) Int. Cl. G06F 11/30

(52) U.S. Cl. 713/155; 713/201; 709/229

(57) ABSTRACT

A network device and system for authentication and a method for authenticating network devices using the network device for authentication. The network system for authentication has a network device for authentication including an authentication information generation unit for generating the authentication information of the network device and an interface unit for transmitting the generated authentication information to the other network devices over the private network, and another network device for authentication including an interface unit for receiving the authentication information over the private network from a network device for requesting authentication and an authentication information registration unit for registering the received authentication information thereon.

This application claims the priority of Korean Patent Application No. 1-2003-0024170 filed on Apr. 16, 2003 in the Korean Intellectual Property Office, the disclosure of which is incorporated herein by reference.

### BACKGROUND OF THE INVENTION

1. Field of Invention

The present invention relates to a network device authentication, and more particularly, to a network device and system for authentication and a method for authenticating network devices using the network device for authentication.

2. Description of the Related Art

FIG. 1 shows a related art authentication process in a wired communication environment. An authentication system for use in the process comprises a network device 120 for requesting authentication, an authentication server 100 for permitting the requested authentication, and a previously authenticated network device 140. Here, a manager registers, within the authentication server 100 and in advance, authentication information 160 regarding a network device 120 to be authenticated. Registered authentication information 170 may include MAC (Medium Access Control) addresses, security keys, SSID (Service Set Identifier) values, etc. of the authentication request network device 120. When the authentication request network device 120 is connected to a network, the authentication information 160 on the authentication request network device 120 is sent to the authentication server 100. Thus, the authentication server 100 confirms the authentication information 160 on the authentication request network device 120 and authenticates the authentication request network device 120.

FIG. 2 shows a related art authentication process in a wireless communication environment. An authentication system for use in the process comprises a wireless network device 220 for requesting authentication, an access point 200 for permitting the requested authentication for the wireless network device, and a previously authenticated network device 240. Here, the access point 200 serves to allocate an address to the authentication request wireless network device 220. A manager registers, on the access point 200 and in advance, authentication information 260 regarding the wireless network device 220 to be authenticated as shown in FIG. 2. When the authentication request wireless network device 220 requests authentication from the access point 200, the access point 200 confirms the authentication information registered on itself and determines whether to permit the requested authentication.

FIG. 3 shows a related art authentication process in a client-server environment. An authentication system for use in the process comprises a client 320 for requesting authentication, and an authentication server 300 for providing service 375 to the client 320. The server 300 contains a service 375 that can be provided to the client, and a list 370 of unique IDs and passwords that the client is permitted to use to access the service. Here, a manager registers, on the server 300 and in advance, a set 360 of IDs and passwords used when the client 320 requests authentication. When the client 320 connects to the server 300 and requests authentication by entering its own ID and password, the authentication server 300 confirms the registered list 370 of IDs and passwords to determine whether the authentication and use of the service 375 are permitted.

FIG. 4 shows an operation process between authenticated network devices using authentication information registered on an authentication server after authentication has been completed through the process as shown in FIG. 1. First, it is assumed that an authentication request network device is a home network device. A home network device A 420 requests connection and use of a service from another home network device B 440, as indicated by an arrow 480. Then, the home network device B 440 requests an authentication server 400 to confirm whether the authentication request home network device A 420 is an authenticated device, as indicated by an arrow 482. Based on an authentication inforamtion list 460, the authentication server 400 checks whether the authentication request home network device A 420 is an authenticated device, and informs the check result of the home network device B 440, as indicated by an arrow 484. Then, the home network device B 440 communicates with the home network device A 420 when it is confirmed that the home network device A 420 is authenticated on the basis of the check result.

However, the related art authentication methods shown in FIGS. 1 to 3 suffer from one or more of the following problems:

1. To authenticate network devices, a manager who has knowledge of the networks or computers is needed.

2. In a wired communication environment, intentional connections from the outside to the network may be made. FIG. 5 illustrates such a problem occurring in a home network, for example. That is, in a home 590 having a wired home network 580 in which an authentication server 500 and home network devices 540 and 542 are interconnected via a wire communication network, an external device 520 can be intentionally connected to a home network 580 through a wired network 585 accessible from the outside.

3. In a wireless communication environment, authentication information may be registered on a network by any authentication request wireless network device present in the other networks, because coverage of the wireless networks is not clearly distinguished. FIG. 6 illustrates such a problem in a wireless home network, for example. That is, in a home 690 having a wireless home network in which an access point 600 and wireless network devices 640 and 642 are interconnected via a wireless link, a wireless link 685 may be established from an external device 620 to the wireless home network, because the coverage of wireless home networks is commonly not distinguished. Accordingly, authentication information not only on the wireless devices 640 and 642 present in the relevant wireless home network but also on the external wireless device 620 present in the other wireless networks may be registered. Therefore, technical solutions for overcoming these related art problems are needed.

### SUMMARY OF THE INVENTION

Accordingly, it is an object of the present invention to allow a general user, who has no knowledge of authentication, computers and the like, to easily perform authentication for network devices, and also allow a user to safely and easily perform authentication for network devices by causing authentication information to be exchanged using an interface with a limited coverage so as to avoid any unauthenticated connection between network devices.

According to one aspect of the present invention for achieving the above object, there is provided a network device for authentication, comprising an authentication information generation unit for generating the authentication information of the network device; and an interface unit for transmitting the generated authentication information to the other network devices over the private network.

According to another aspect of the present invention, there is also provided a network device for authentication, comprising an interface unit for receiving the authentication information over the private network from a network device for requesting authentication; and an authentication information registration unit for registering the received authentication information thereon. Preferably, the authentication information includes information on a network device for requesting authentication, information on a network device for registering the authentication information, an authentication information identifier, or the like. More preferably, the interface unit includes a transceiver unit for local area communication, and the local area communication includes wireless communication such as IrDA communication and blue tooth communication, and wired communication such as serial communication and parallel communication.

According to a further aspect of the present invention, there is provided a network system for authentication, comprising a first network device including an authentication information generating unit for generating its own authentication information and an interface unit for transmitting the generated authentication information to other network devices over a private network; and a second network device including an interface unit for receiving the authentication information over the private network and an authentication information registration unit for registering the received authentication information thereon. Preferably, the network system further comprises a network device for receiving the authentication information transmitted from the first network device over the private network and transmitting the received authentication information over the private network to the second network device. More preferably, the authentication information includes information on a network device for generating its own authentication information, information on a network device for registering the authentication information, an authentication information identifier, or the like. More preferably, the interface unit includes a transceiver unit for local area communication, and the local area communication includes wireless communication such as IrDA communication and blue tooth communication, and wired communication such as serial communication and parallel communication.

According to a still further aspect of the present invention, there is provided a method for authenticating network devices, comprising generating authentication information on a specific network device and transmitting the generated authentication information to other network devices over a private network; and receiving the transmitted authentication information over the private network and registering the received authentication information on another network device. Preferably, the authentication information includes information on a network device for generating its own authentication information, information on a network device for registering the authentication information, an authentication information identifier, or the like.

According to a still further aspect of the present invention, there is provided a method of authenticating network devices, comprising generating authentication information of a specific network device and transmitting the generated authentication information to other network devices over a private network; repeating the authentication information transmitted in the generation of the authentication information step over the private network (to transmit the information over the private network); and receiving the authentication information transmitted in the repeating step over the private network and registering the received authentication information on another network device. Preferably, the authentication information includes information on a network device for generating its own authentication information, information on a network device for registering the authentication information, an authentication information identifier, or the like.

According to a still further aspect of the present invention, there is provided a network device for authentication, which receives a unique key generated by a unique key generating device over a private network and transmits the received unique key and authentication information that is generated by the network device.

According to a still further aspect of the present invention, there is provided a network device for authentication, wherein the network device receives authentication information and a first unique key from a network device for requesting authentication, receives a second unique key generated by a unique key generating device over a private network, compares the first unique key with the second unique key, and registers the authentication information thereon when both keys match. Preferably, the authentication information includes information on a network device for generating its own authentication information, information on a network device for registering the authentication information, an authentication information identifier, or the like.

According to a still further aspect of the present invention, there is provided a network system for authentication, comprising a unique key generating device for generating unique keys; a first network device for transmitting a first unique key received through a private network from the unique key generating device and authentication information generated by the first network device; and a second network device for comparing the first unique key received from the first network device with a second unique key received over a private network from the unique key generating device, and registering the received authentication information received from the first network device thereon when both keys match. Preferably, the authentication includes information on the first network device, information on the second network device, authentication information identifier, or the like.

According to a still further aspect of the present invention, there is provided a method of authenticating network devices, comprising transmitting a first unique key received over a private network and authentication information generated by a network device that has received the first unique key; and receiving the first unique key and the authentication information, comparing the received first unique key with a second unique key received over the private network, and registering the received authentication information when both keys match. Preferably, the authentication information includes information on a network device for transmitting the authentication information, information on a network device for registering the authentication information, an authentication information identifier, or the like.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a diagram illustrating a related art authentication process in a wired network environment;

FIG. 2 is a diagram illustrating a related art authentication process in a wireless network environment;

FIG. 3 is a diagram illustrating a related art authentication process in a client-server environment;

FIG. 4 is a diagram illustrating an operating process between authenticated network devices after the authentication has been completed, according to the related art;

FIG. 5 is a diagram showing problems in a related art wired home network;

FIG. 6 is a diagram showing problems in a related art wireless home network;

FIG. 7 is a diagram illustrating a process of transmitting authentication information through interface units of network devices according to an embodiment of the present invention;

FIG. 8 is a diagram illustrating a process of transmitting authentication information through interface units of network devices using a repeater according to another embodiment of the present invention;

FIG. 9 is a diagram illustrating a process of transmitting authentication information through interface units of network devices using a unique key according to a further embodiment of the present invention;

FIG. 10 illustrates a format of an authentication information message for an authentication request network device according to an embodiment of the present invention;

FIG. 11 is a process flowchart for illustrating an authentication method in an environment as shown in FIG. 7;

FIG. 12 is a process flowchart for illustrating an authentication method in an environment as shown in FIG. 9;

FIG. 13 is a diagram illustrating an operating process for network devices operating in a wired network environment after authentication has been completed, according to the present invention; and

FIG. 14 is a diagram illustrating an operating process for network devices operating in a wireless network environment after authentication has been completed, according to the present invention.

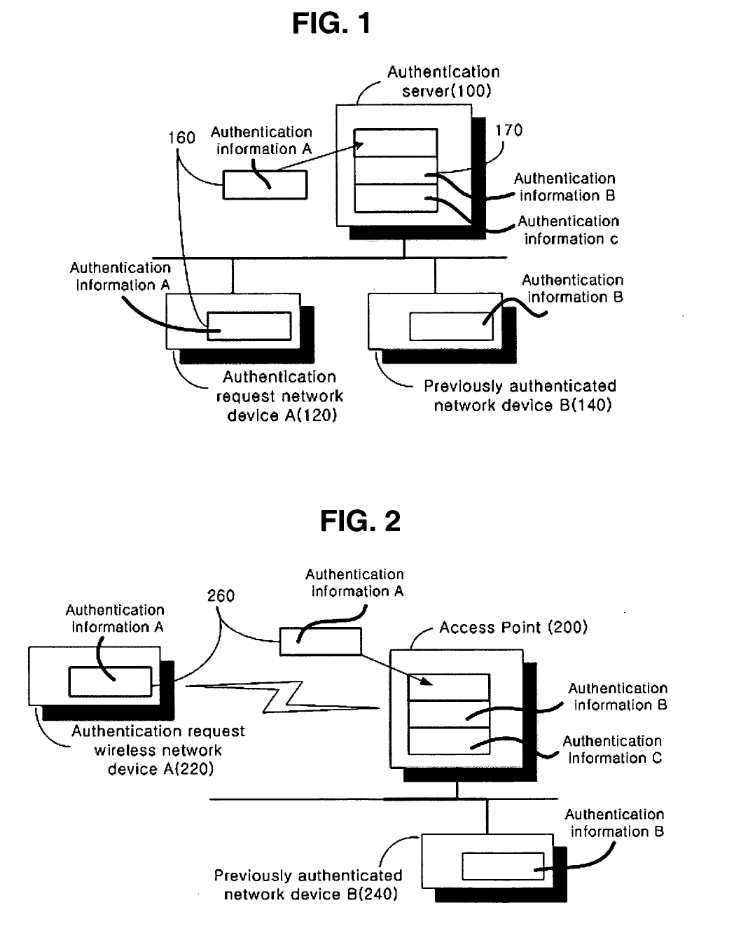

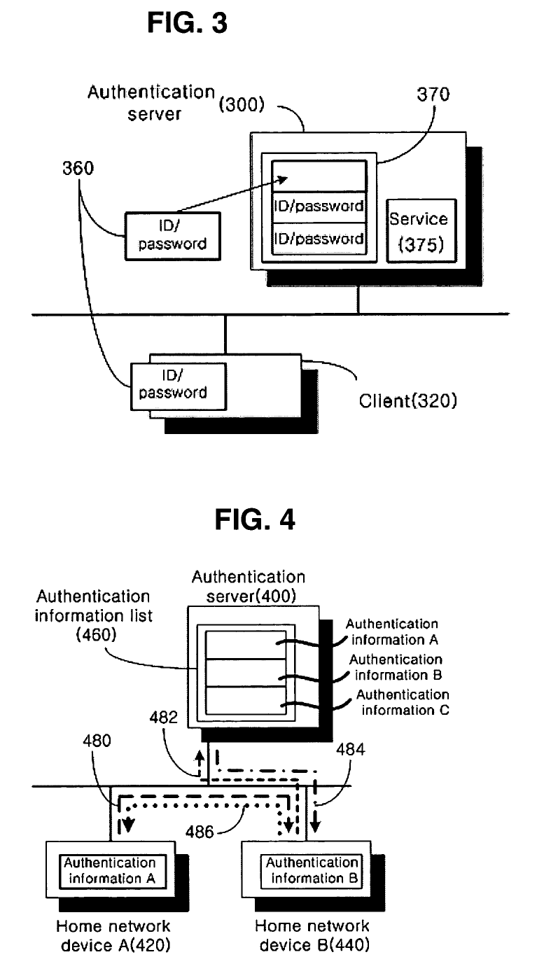

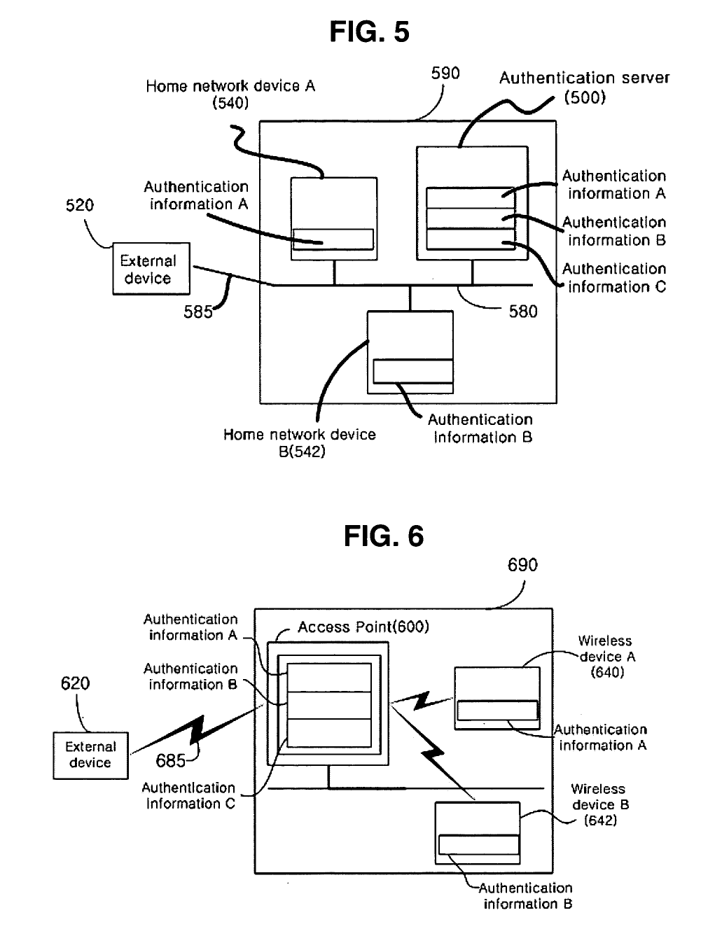

### DETAILED DESCRIPTION OF THE INVENTION

Prior to a detailed description of the present invention, some definitions on terminologies provided herein are first discussed as follows:

1. Authentication Information:

Corresponds to information needed for authentication and includes information on an authentication request network device, authentication information identifier, etc.

2. Authentication Information Identifier:

Corresponds to an identifier for discriminating whether a message to be transmitted contains authentication information.

3. SSID (Service Set Identifier):

Corresponds to a unique identifier of 32-byte length, which is added to each header of packets transmitted over a wireless LAN.

4. Bluetooth:

Corresponds to a wireless Internet connection scheme over a local area network.

Hereinafter, a network device and system for authentication and a method for authenticating network devices using such a network device according to a preferred embodiment of the present invention will be described with reference to the accompanying drawings.

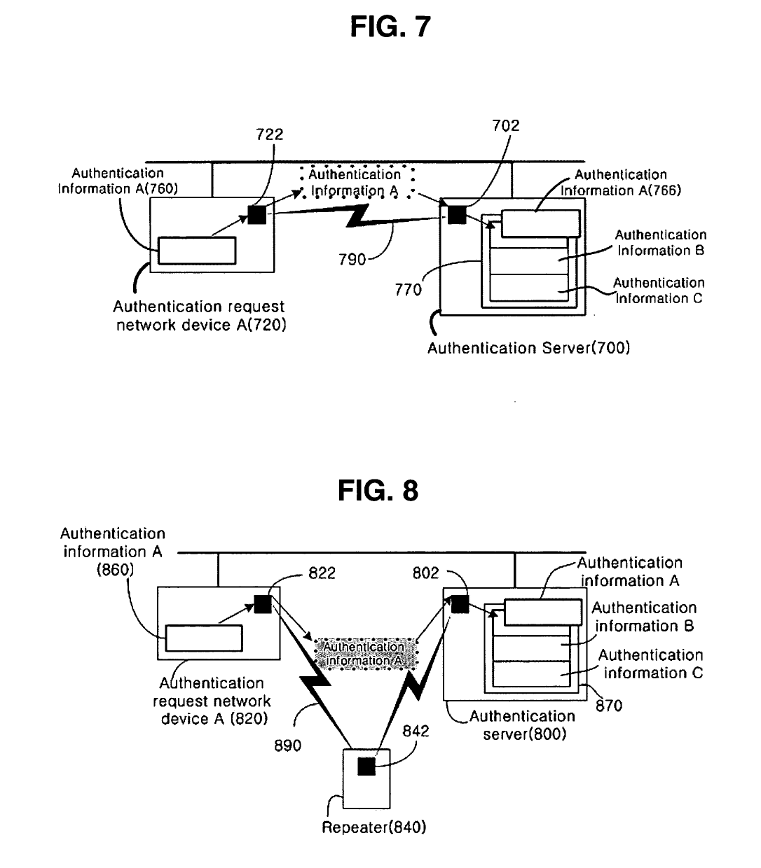

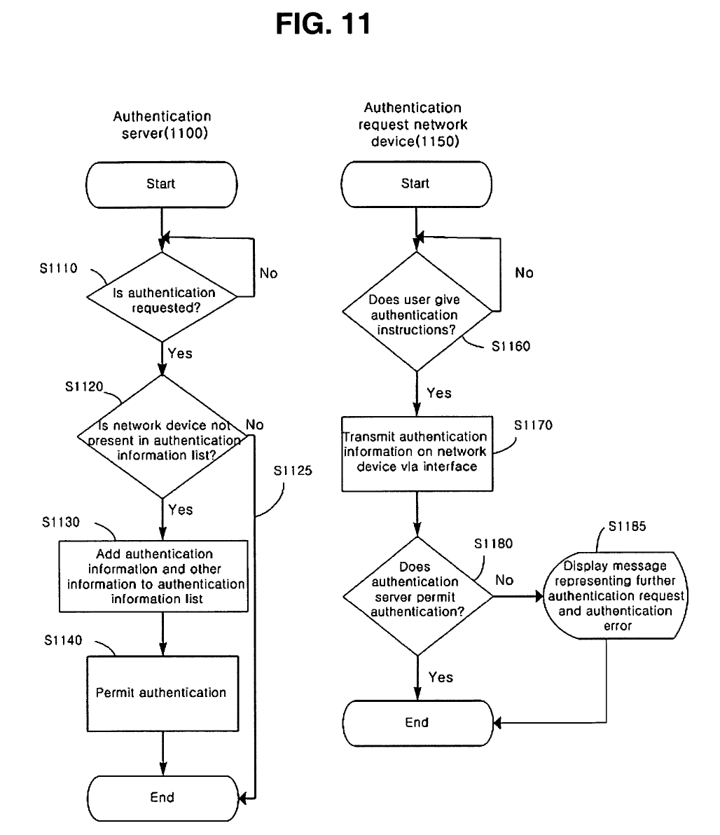

FIG. 7 is a diagram illustrating a method for authenticating network devices according to an embodiment of the present invention. A user instructs a network device 720 to request authentication from an authentication server 700. Then, authentication information 760 on the authentication request network device 720 is transmitted to the authentication server 700 via an interface 722 of the network device 720 over a private network 790. At this time, the user may instruct to permit the authentication using an authentication button attached to the network device 720, an application program for authentication and the like. Interfaces 702 and 722 are wired/wireless interfaces with limited coverage and directivity, and include local area communication interfaces such as IrDA (Infra-red Data Association) communications and blue tooth communications, or wire cable interfaces such as serial/parallel cables with a closure property. The authentication server 700 checks whether an authentication information list 770 of the server contains the authentication information 766 received through the interface 702. If authentication information 766 is not present in the list, the server adds the authentication information 766 on the network device 720 to the authentication information list 770 and then completes the authentication process. FIG. 11 is a process flowchart illustrating the authentication method shown in FIG. 7, which will be described later.

FIG. 8 is a diagram illustrating a method for authenticating network devices using a repeater according to another embodiment of the present invention. The repeater 840 simply receives authentication information 860 on an authentication request network device 820 via its own interface 842 over a private network 890 and sends the authentication information 860 to an interface 802 of an authentication server 800. The authentication server 800 checks whether the authentication information on the authentication request network device 820 from the repeater 840 is present in an authentication information list 870. If it is not present, the authentication server 800 adds the authentication information to the authentication information list 870 and completes the authentication process. At this time, the repeater may be used in the form of a remote control. According to this embodiment shown in FIG. 8, a user can perform authentication for the authentication request network device 820 within a local area without directly contacting the authentication request network device 820.

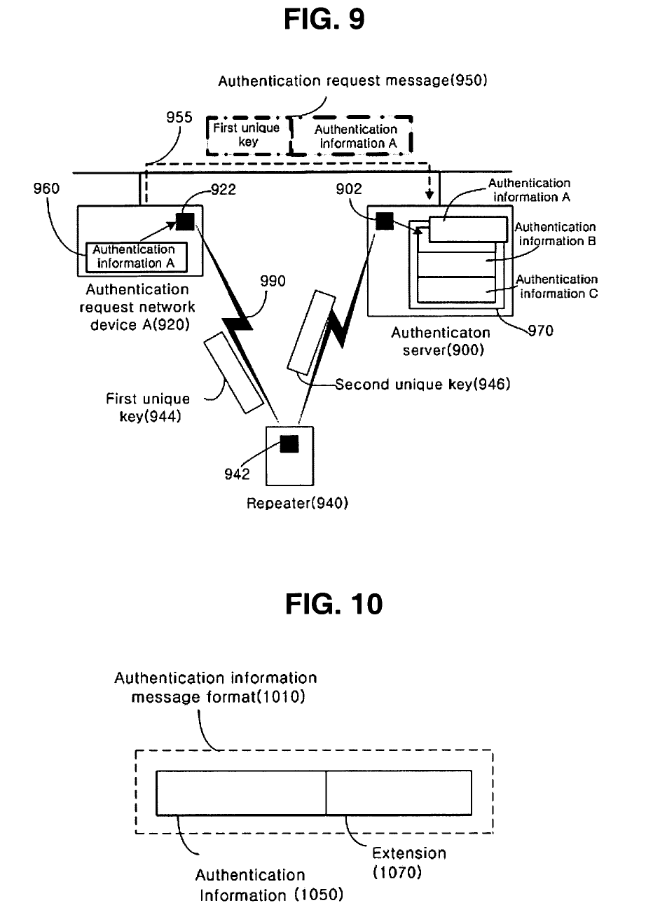

FIG. 9 is a diagram illustrating a method for authenticating network devices using a unique key according to a further embodiment of the present invention. A repeater 940 sends a first unique key 944 and a second unique key 946 via its own interface 942 over a private network 990 to an interface 922 of an authentication request network device 920 and an interface 902 of an authentication server 900, respectively. The authentication request network device 920 generates an authentication request message 950 using the first unique key 944 and authentication information 960 and sends the generated message 950 to the authentication server 900.

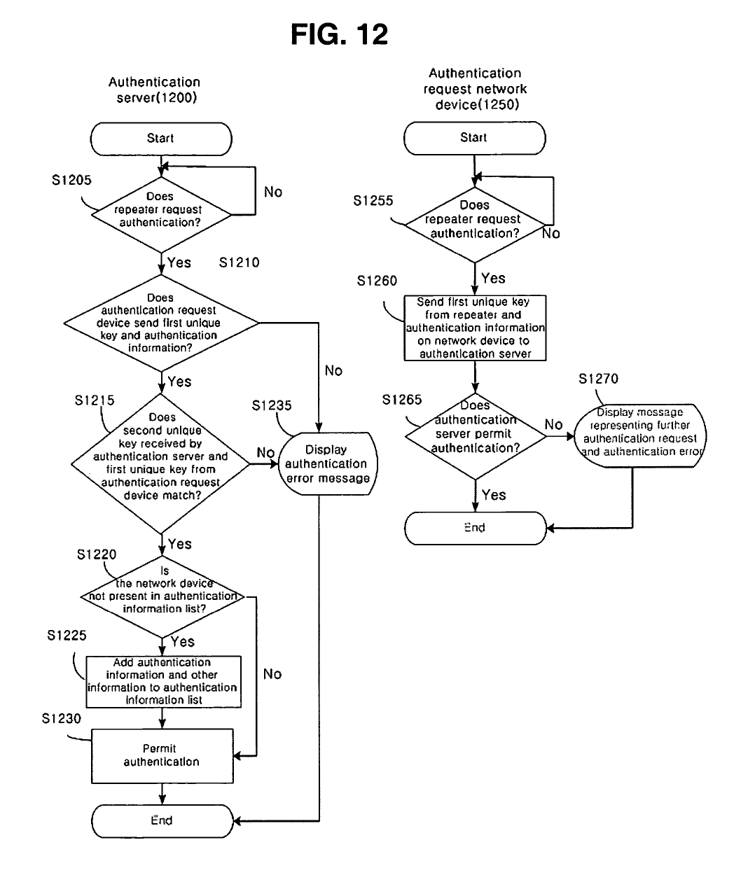

After receiving the authentication request message 950, the authentication server 900 compares the second unique key 946 to the first unique key 944 included in the authentication request message 950. If the two keys match, the authentication server checks whether the authentication information included in the authentication request message 950 is present in the authentication information list 970. Then, if it is not present, the authentication server adds the authentication information to the list and completes the authentication process. FIG. 12 is a process flowchart illustrating the authentication method shown in FIG. 9, which will be described later. According to this embodiment shown in FIG. 9, the user can prevent intentional connection from the outside to the network by comparing the first unique key 944 with the second unique key 946 even while using the existing general network other than the private network.

FIG. 10 illustrates a format of an authentication information message for an authentication request network device according to an embodiment of the present invention. The authentication information message 1010 includes authentication information 1050, and alternatively may include an extension 1070 in addition to the authentication information 1050. The authentication information 1050 may include information on the authentication request network device, information on the authentication information registering network device, an identifier for discriminating whether the message includes authentication information, and the like. The information on the authentication request network device may include a security key, an MAC (Medium Access Control) address, an SSID, etc. The authentication information message 1010 may include the extension 1070 to deliver any information other than the authentication information 1050.

FIG. 11 is a process flowchart illustrating the authentication method shown in FIG. 7. An authentication server 1100 checks whether there is an authentication request from an authentication request network device 1150 (S1110). If it is checked that there is an authentication request, the authentication server 1100 checks whether the authentication information about the authentication request network device 1150 is included in its own authentication information list (S1120). If the authentication information on the authentication request network device 1150 is not included in the authentication information list, the authentication server will not permit the authentication and completes the authentication process (S1125). Otherwise, the authentication server adds the authentication information and the other information about the network device 1150 to the authentication information list (S1130) and permits the authentication (S1140).

On the other hand, the authentication request network device 1150 confirms whether a user issues authentication instructions (S1160). If the user issues authentication instructions, the authentication request network device sends its own authentication information via its own interface over a private network (S1170). Then, if the authentication server permits the authentication, the authentication process will be completed. Otherwise, a message for indicating a further authentication request or an authentication error can be displayed (S1185).

FIG. 12 is a process flowchart illustrating the authentication method shown in FIG. 9. An authentication server 1200 checks whether a repeater makes a request for authentication (S1205). If there is an authentication request from the repeater, the authentication server checks whether the authentication request network device 1250 sends a first unique key and authentication information to the server (S1210). Unless receiving the first unique key and the authentication information from the authentication request device 1250, the authentication server 1200 displays authentication error message or completes the authentication process (S1235). Otherwise, the authentication server 1200 compares the first unique key received from the authentication request device 1250 with a second unique key received from the repeater and then checks whether both keys match (S1215). If the two keys are the same, the authentication server 1200 checks whether authentication information from the authentication request device 1250 is included in an authentication information list of the authentication server. If the authentication information is included in the list, the authentication server permits the authentication (S1230). Otherwise, however, the authentication server adds the authentication information and the other information on the device 1250 to the authentication information list (S1225) and then permits the authentication (S1230). On the other hand, the authentication request network device 1250 confirms whether the repeater make a request for authentication (S1255). When the repeater has made a request for authentication, the network device 1250 sends the first unique key from the repeater and its own authentication information to the authentication server 1200 (S1260). Then, if the authentication server 1200 permits authentication, the authentication process will be completed. Otherwise, the server will display a message for indicating a further authentication request or an authentication error (S1270) and then completes the authentication process.

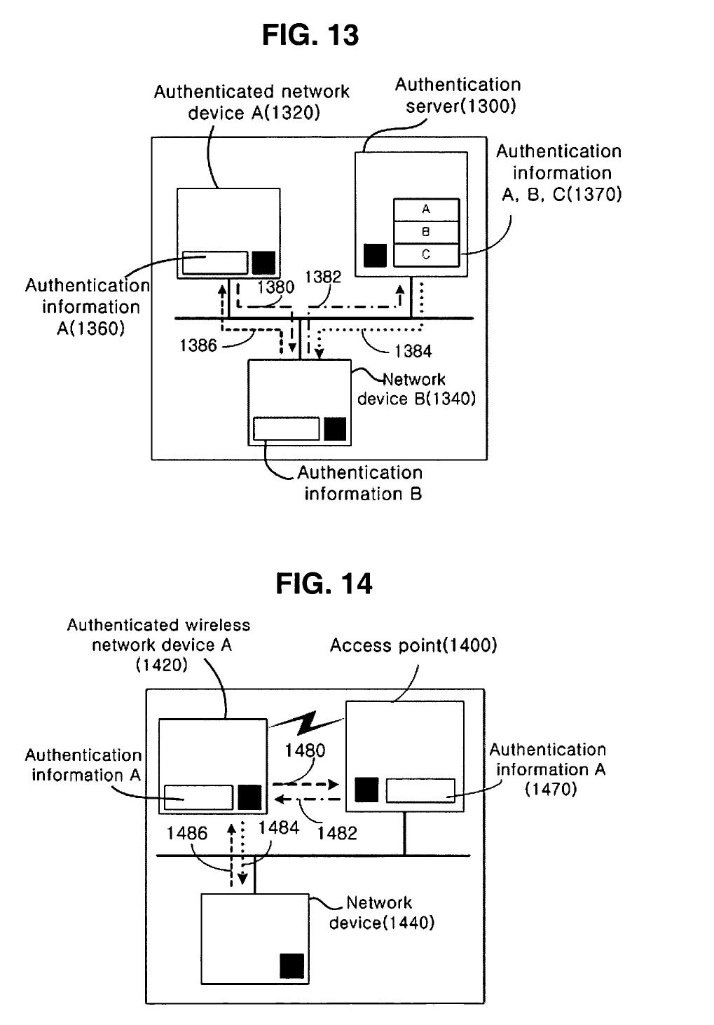

FIG. 13 illustrates a process of operating authenticated network devices in a wired network environment according to an embodiment of the present invention. An authenticated network device A 1320 transmits a message including its own authentication information 1360 to communicate with another network device B 1340, as indicated by an arrow 1380. After receiving the message, the network device B 1340 transmits the authentication information contained in the received message to an authentication server 1300 and requests the server 1300 to confirm whether the network device A 1320 has been authenticated, as indicated by an arrow 1382. Then, the authentication server 1300 checks whether the authentication information contained in the received message is included in its own authentication information list 1370, and sends the result to the network device B 1340 that has requested confirmation, as indicated by an arrow 1384. Finally, the network device B 1340 confirms that the network device A 1320 has been authenticated and then communicates with the network device A, as indicated by an arrow 1386.

FIG. 14 illustrates a process of operating authenticated network devices in a wireless network environment according to another embodiment of the present invention. The authenticated wireless network device 1420 sends, to an access point 1400, a request for connection to anther network device, as indicated by an arrow 1480. In response to the request, the access point 1400 authenticates the wireless network device 1420 using its own authentication information list 1470 and assigns a predetermined address to the wireless network device, as indicated by an arrow 1482. Then, the wireless network device 1420 sends the other network device 1440 a request for connection thereto, as indicated by an arrow 1484. Thus, the requested network device 1440 permits the connection, as indicated by an arrow 1486.

According to the present invention configured as such, the following advantages can be obtained.

1. In a network environment that is not managed by a manager, authentication for network devices can be done.

2. A general network user who has no knowledge of networks or authentication can easily perform an authentication process.

3. In a wired or wireless network environment, intentional unauthorized or accidental connection to the network or use of service can be easily and effectively prevented by a predetermined interface.

Although the present invention has been described in connection with the embodiments of the present invention shown in the accompanying drawings, it is not limited thereto. It will be apparent to those skilled in the art that various substitutions, modifications and changes may be made thereto without departing from the scope and spirit of the invention.

What is claimed is:

1. A network device, comprising:
an authentication information generation unit operable to generate the authentication information of the network device; and
an interface unit operable to transmit the generated authentication information to the other network devices over the private network.

2. A network device as claimed in claim 1, wherein the network device generates its own authentication information and transmits the generated authentication information to other network devices over a private network.

3. A network device for authentication, wherein the network device receives authentication information over a private network and registers the received authentication information thereon.

4. The network device as claimed in claim 3, comprising:
an interface unit operable to receive the authentication information over the private network from a network device for requesting authentication; and
an authentication information registration unit operable to register the received authentication information thereon.

5. A network device for authentication, wherein the network device receives authentication information from a specific network device over a private network and transmits the received authentication information over the private network to other network devices.

6. The network device as claimed in any one of claims 1, 3, and 5, wherein the authentication information includes information on a network device for requesting authentication.

7. The network device as claimed in any one of claims 1, 3, and 5, wherein the authentication information includes information on a network device for registering the authentication information.

8. The network device as claimed in any one of claims 1, 3, and 5, wherein the authentication information includes an authentication information identifier.

9. The network device as claimed in either claim 2 or 4, wherein the interface unit includes a transceiver unit for local area communication.

10. The network device as claimed in claim 9, wherein the local area communication includes IrDA communication.

11. The network device as claimed in claim 9, wherein the local area communication includes Bluetooth communication.

12. The network device as claimed in claim 9, wherein the local area communication includes wired serial communication.

13. The network device as claimed in claim 9, wherein the local area communication includes wired parallel communication.

14. A network system for authentication, comprising:
a first network device including an authentication information generating unit operable to generate its own authentication information and an interface unit operable to transmit the generated authentication information to other network devices over a private network; and
a second network device including an interface unit operable to receive the authentication information over the private network and an authentication information registration unit operable to register the received authentication information thereon.

15. The network system as claimed in claim 14, further comprising:
a network device operable to receive the authentication information transmitted from the first network device over the private network and transmit the received authentication information over the private network to the second network device.

16. The network system as claimed in claim 14, wherein the authentication information includes information on the first network device for generating its own authentication information.

17. The network system as claimed in claim 14, wherein the authentication information includes information on the second network device for registering the authentication information thereon.

18. The network system as claimed in claim 14, wherein the authentication information includes an authentication information identifier.

19. The network system as claimed in claim 14, wherein the interface unit includes a transceiver unit for local area communication.

20. The network system as claimed in claim 19, wherein the local area communication includes IrDA communication.

21. The network system as claimed in claim 19, wherein the local area communication includes Bluetooth communication.

22. The network system as claimed in claim 19, wherein the local area communication includes wired serial communication.

23. The network system as claimed in claim 19, wherein the local area communication includes wired parallel communication.

24. A method for authenticating network devices, comprising:
generating authentication information on a specific network device and transmitting the generated authentication information to other network devices over a private network; and
receiving the transmitted authentication information over the private network and registering the received authentication information on another network device.

25. A method of authenticating network devices, comprising:
generating authentication information of a specific network device and transmitting the generated authentication information to other network devices over a private network;
repeating the authentication information transmitted in the generating step over the private network; and
receiving the authentication information transmitted in the repeating step over the private network and registering the received authentication information on another network device.

26. The method as claimed in either claim 24 or 25, wherein the authentication information includes information on the specific network device for generating its own authentication information.

27. The method as claimed in either claim 24 or 25, wherein the authentication information includes information on another network device for registering the authentication information thereon.

28. The method as claimed in either claim 24 or 25, wherein the authentication information includes an authentication information identifier.

29. A network device for authentication, wherein the network device receives a unique key generated by a unique key generating device over a private network and transmits the received unique key and authentication information that is generated by the network device.

30. A network device for authentication, wherein the network device receives authentication information and a first unique key from a network device for requesting authentication, receives a second unique key generated by a unique key generating device over a private network, compares the first unique key with the second unique key, and registers the authentication information thereon when both keys match.

31. A first network device for authentication, wherein the first network device generates a unique key and transmits the generated unique key to a second network device for requesting authentication and a third network device for receiving authentication request from the second network device.

32. The network device as claimed in either claim 29 or 30, wherein the authentication information includes information on a network device for requesting authentication.

33. The network device as claimed in either claim 29 or 30, wherein the authentication information includes information on a network device for registering authentication information.

34. The network device as claimed in either claim 29 or 30, wherein the authentication information includes an authentication information identifier.

35. A network system for authentication, comprising:
a unique key generating device operable to generate unique keys;
a first network device operable to transmit a first unique key received through a private network from the unique key generating device and authentication information generated by the first network device; and
a second network device operable to compare the first unique key received from the first network device with a second unique key received over a private network from the unique key generating device, and registering the received authentication information received from the first network device thereon when both keys match.

36. The network system as claimed in claim 35, wherein the authentication information includes information on the first network device.

37. The network system as claimed in claim 35, wherein the authentication information includes information on the second network device.

38. The network system as claimed in claim 35, wherein the authentication information includes an authentication information identifier.

39. A method of authenticating network devices, comprising:
transmitting a first unique key received over a private network and authentication information generated by a network device that has received the first unique key;
receiving the first unique key and the authentication information;
comparing the received first unique key with a second unique key received over the private network; and
registering the received authentication information when both keys match.

40. The method as claimed in claim 39, wherein the authentication information includes information on the network device for transmitting the authentication information.

41. The method as claimed in claim 39, wherein the authentication information includes information on a network device for registering the authentication information.

42. The method as claimed in claim 39, wherein the authentication information includes an authentication information identifier.
